(19) United States
(12) Patent Application Publication
(10) Pub. No.: US 2007/0211752 A1
(43) Pub. Date: Sep. 13, 2007

(54) Method of establishing a PPP session over an air interface

(75) Inventors: Chandra Warrier, Schaumburg, IL (US); Abhishek Sharma, Streamwood, IL (US); Quan Choi, Port Barrington, IL (US)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: UTStarcom, Incorporated, Rolling Meadows, IL (US)

(21) Appl. No.: 11/374,441

(22) Filed: Mar. 13, 2006

(51) Int. Cl. H04J 3/22

(52) U.S. Cl. 370/465; 370/352

(57) ABSTRACT

A method of establishing a Point-to-Point (PPP) session over an air interface is described. In order to provide access to a Circuit Switched Data (CSD) server on a CSD network, a Packet Data Serving Node (PDSN) establishes a PPP session on behalf of an InterWorking Function (IWF). This establishment of the PPP session allows a mobile 3G device to setup a TCP session with the IWF. The mobile 3G device may communicate modem emulation data to the IWF and thereby use a modem in the IWF to communicate over the CSD network with the CSD server.

### FIELD

The present invention relates generally to a method of establishing a Point-to-Point Protocol (PPP) session over an air interface and more particularly, a method of operating a Packet Data Serving Node (PDSN) to establish a PPP session.

### BACKGROUND

Today's Mobile 3G standards are an answer to the International Telecommunications Union's IMT-2000 specification. Key features of the IMT-2000 specification include: a high degree of commonality of design worldwide, compatibility of services within IMT-2000 and fixed networks, worldwide roaming capability, capability for multimedia applications, a wide range of services and terminals, and high reliability.

Current mobile 3G standards for transmitting signals over an air interface are divided primarily into four camps. Generally, the four standards for the air interface are: Universal Mobile Telephone System (UMTS), Code Division Multiple Access (CDMA) 2000, Time Division-Synchronous CDMA (TD-SCDMA), and Wideband CDMA. All of these standards offer improved efficiency, bandwidth, and performance in comparision to 2G standards (e.g., Time Division Multiple Access (TDMA) and CDMA). In FIG. 1A, the air interface, referred to as “U_{M},” provides a coupling between a 3G mobile device 102 and a Base Station Controller/Packet Control Function 105 (BSC/PCF). The BSC/PCF is then coupled to a Packet Data Serving Node 104 (PDSN).

The 3G air interface is not the only improvement that mobile 3G networks incorporate, however. The PDSN 104 allows a 3G mobile device, such as mobile 102, to send and receive data packets over an air interface to a network 106. These data packets may be routed using covential IP routing or Mobile IP routing procedures. The interface between the PDSN and the network 106 is generally referred to as the “P_{I}” interface. The P_{I} interface may be an Ethernet connection that provides a coupling to a network server, for example. The PDSN is coupled at an “R-P” interface to BSC/PCF 105. The PCF included in BSC/PCF 105 provides “packetizing” and “de-packetizing” functionality for communications received at the BSC/PCF 105.

The PDSN 104 promotes packet switching by serving as an endpoint of a Point-to-Point Protocol (PPP) session with mobile 102. To setup the PPP session, the PDSN and the mobile 102 undergo standard PPP setup procedures such as Link Control Protocol (LCP) setup, Challenge Handshake Authentication Protocol/Password Authentication Protocol (CHAP/PAP) setup (including Access Authorization and Authentication (AAA)), and Internet Protocol Configuration Protocol (IPCP) negotiations. Once a PPP session is setup between mobile 102 and the PDSN 104, a TCP/IP session may be established with another device on network 106, thereby allowing packet-based data to be exchanged.

In contrast to mobile 3G networks, mobile 2G networks use an InterWorking Function (IWF) to exhange data over a network. A block diagram of a mobile 2G network is illustrated in FIG. 1B. A 2G mobile device, referred to as TM2 device 108, is coupled to a laptop or other type of portable computing device, refered to as TE2 device 110. TE2 device 110 includes application software that is used to transceive packet based data. A serial connection (defined by Electronic Industries Association (EIA) standard 232, for example) may couple TE2 device 110 to MT2 device 108. The interface between these two devices is generally referred to as the “R_{M}” interface. Alternatively, TE2 device 102 and MT2 device 104 may be adapted so that they are integrated into a single device. In any case, TE2 device 102 and MT2 device 104, when coupled together, comprise a 2G Mobile Station (MS) 112.

MS 112 communicates wirelessly over a 2G air interface (i.e. TDMA, CDMA, etc.) with Base Station/Mobile Switching Center (BS/MSC) 114. An IWF 116 couples BS/MSC 114 to a Circuit Switched Data (CSD) network 118, such as the Public Switched Telephone Network (PSTN). The interface between BS/MSC 114 and IWF 116 is referred to as an “L” interface. IWF 116 serves as an endpoint of a PPP and a TCP session with MS 112, and provides a modem 117 that may be used to establish a data session with another modem CSD network 118.

At a terminating end of CSD network 118 is a modem, such as modem 120 or 122. Modems 120 and 122 may provide access to a variety of different networks. For example, modem 120 provides access to network 106, which may be a public network. Modem 122, on the other hand, provides access to a private network 124, which may be used by a financial institution, for example. Generally, IWF 116 and MS 112 each include an application interface that support EIA/TIA standardized modem control commands, and together provide an interface compatible with those encountered in practical modem implementations.

In most applications that exchange data over a mobile 3G network (as illustrated in FIG. 1A), a network layer coupling to network 106 is more efficient than the CSD coupling as shown in FIG. 1B. As a result, data transmission rates are higher in mobile 3G networks in comparison to mobile 2G networks. In addition, the 3G air interface also provides an improvement in comparison to a 2G air interface.

Despite the advantages of using a mobile 3G network, in some instances it may be desirable to use a dial-up access infrastructure without incurring the expense of adding a paket interface or replacing the dial-up infrastructure. In another instance, some legacy 2G based system may not be compatable with current mobile 3G networks. Such legacy systems include antiquated networks, such as those that may be used in developing or third world countries. A financial institution located in such a third world country, for example, may not be able to afford the costs associated with upgrading their private and/or secured network. Moreover, the modem access as is shown in FIG. 1B, may provide a measure of security to the financial insitution. In this case, migrating to a direct network layer coupling to a PDSN may be not be advantageous to the financial institution.

In FIG. 2A, a block diagram including simplified protocol stacks of TE2 device 110, TM2 device 108, BS/MSC 114, IWF 116, and a CSD server 200 are illustrated. In this diagram, the protocol diagrams illustrate, in a simplified manner, how TE2 device 110 exchanges application data from application layer 202 with CSD server 200. Between TE2 device 108 and IWF 116 the application data is “packetized”. Between IWF 116 and CSD server, however, the application data is “non-packetized,” or circuit switched. At a lower protocol level the packetized application data includes modem emulation data. The modem emulation data controls a modem located in IWF 116. The modem in IWF 116 is one endpoint of the modem to modem coupling between IWF 116 and CSD server 200 over the CSD network coupling 118.

To exchange the application data over the air interface the TE2 device is coupled through an R_{M} interface to TM2 device 108 via a serial RS-232 protocol 204. As described above, TM2 device 108 and TE2 device 110, when coupled together, comprise MS 112. Serving as a radio link endpoint, TM2 device 108 exchanges the application data over the air interface on behalf of TE2 device 110. BS/MSC 114, also serving as a radio link endpoint, exchanges the application data with TM2 device 108.

In order to exchange data over the air interface, TM2 device 108 and BS/MSC 114 use a Radio Link Protocol (RLP) 206. For 2G networks, one such RLP is described in the interim standard TIA-EIA-95. Also included in the protocol layers of TM2 device are PPP protocols 208, TCP/IP protocols 210, and application interface protocols 212. PPP protocols 208 are used in establishing and maintaining a PPP session with IWF 116. TCP/IP protocols 210 are used to establish and maintain a TCP session with IWF 116. The application interface protocols 212 are used to communicate the modem emulation data. Relay layer protocols 214, are used over an L interface between BS/MSC 114 and IWF 116 to exchange the application data. The L interface may be Ethernet, for example.

At IWF 116, both the PPP and TCP sessions are terminated. As described above, the modem emulation data that is communicated from TM2 device 108 is used to control the modem located in IWF 116. IWF 116 may exchange data with CSD server 200 using circuit switched protocols. In contrast to the protocol stacks illustrated in FIG. 2A, a mobile 3G network may transmit packetized data between a mobile 3G device and a computer (or a server) in packetized form without using a CSD network. Simplified protocol stacks used in a mobile 3G network are illustrated in FIG. 2B.

In order to communicate over a 3G air interface, a mobile 3G device 102 exchanges data with a BSC/PCF 105. Similar to the TM2 device 108 in FIG. 2A, the mobile 102 protocol stack includes PPP protocols 208 and TCP/IP protocols 210. The PPP protocols 208 are used to establish a PPP session between the PDSN 104 and the mobile 102. The TCP/IP protocols 210, on the other hand, are used to establish a TCP/IP session with a computer 220 on a packet based network and the mobile 102. Application data may be exchanged between the computer 220 and the mobile 102 at an upper layer application protocol 222.

The BSC/PCF 105 is used as a termination point of the air interface coupling of mobile 102 to the 3G mobile network. A mobile 3G based standard may be used for RLPs 224, which are used to communicate between BSC/PCF 105 and mobile 102. BSC/PCF may used Generic Routing Encapsulation Protocols (GRE) 226 along with IP transport layer protocols 228 in order to exchange data over an R-P interface between BSC/PCF 105 and PDSN 104. Relay layer protocols 230, such as Ethernet, may be used over the R-P interface.

As described above, once a PPP session is established between the mobile 102 and PDSN 104, a TCP/IP session may be established between computer 220 and mobile 102. IP routing protocols 232 and link layer protocols 234 may be used over a P_{I} interface to provide data exchange between the PDSN 104 and computer 220. The application data may then be exchanged through a TCP socket in the TCP session.

In some circumstances it may be desirable to maintain a CSD coupling to a mobile network, such as those described above. However, one barrier that prevents such a coupling from being achieved is the fact that the PDSN in mobile 3G networks terminates a PPP session. In legacy systems, this task was accomplished by the IWF. Because of this, legacy systems cannot use existing or conventional IWFs to provide a coupling through a CSD network. Therefore, there is a need for a way of to establish communications with an IWF from a 3G network. This would faciliate interoperability of legacy systems with a mobile 3G infrastructure.

### SUMMARY

A method of operating a Packet Data Serving Node (PDSN) is presented. The method includes utilizing an IP address of an InterWorking Function (IWF) to establish a Point-to-Point Protocol (PPP) session between a Mobile Station (MS) and the PDSN. By acting on behalf of the IWF, network layer packets having a destination address of the IWF may be received at the PDSN. These network layer packets may then be forwarded to the IWF.

In one example, Internet Protocol Configuration Protocol (IPCP) negotiations are used to setup a PPP session between the MS and the PDSN on behalf of the IWF. IP routing procedures are then used to route the network layer packets from the PDSN to the IWF. The PDSN preferably obtains information about the IWF (such as the IWF IP address) that may then be used to complete the IPCP negotiations and thus setup the PPP session.

Once the PPP session is set up, a TCP session may be established between the MS and the IWF. Upon TCP session setup, TCP/IP packets may then be exchanged between the MS and the IWF. In addition, the IWF and the PDSN may contain software that facilitates the setup of the PPP session with an endpoint at the PDSN and the maintenance of a subsequent TCP/IP session endpoint at the IWF.

Advantageously, because the PDSN has provided the MS with the IWF IP address (during the PPP negotiation), the packets received from the MS via the PDSN PPP layer are already addressed to the IWF at the network IP layer. As a result, the PDSN can simply forward the packets to the IWF using standard IP routing procedures. In an alternative example, a tunneling protocol, such as the Layer 2 Tunneling Protocol (L2TP), IP in IP, or Generic Routing Encapsulation (GRE) in IP, may be used to communicate network layer data from the PDSN to and from the IWF.

In another example, the PDSN includes a PPP module. Preferably, when a MS submits a connection request to the PDSN, the PDSN submits a request for authentication to a Authentication, Authorization, and Accounting (AAA) server. The request preferably conforms to the RADIUS protocol, and includes data indicating that a 2G-based modem session should be provisioned via an IWF. Preferably the identifying data is the MS IMSI and/or user domain name. The AAA server responds with an indication that the PPP module should act as an IWF PPP proxy by “spoofing” the IP address of the IWF. Preferably, the AAA server provides the PDSN with the IP address of the IWF. The AAA server may select the IWF IP address statically, from an address pool, and/or based on a load balancing algorithm.

The PDSN PPP module may receive a RADIUS accept message that includes data that includes an IWF forwarding indicator, for example. The IWF forwarding indicator may indicate that the PPP module is to establish a PPP session using the IP address of the IWF. In yet another example, modem emulation data may be communicated from the MS to the IWF via the PDSN. The modem emulation data may be contained within the network layer packets and it may be used to communicate AT commands to a modem in the IWF.

These as well as other aspects and advantages will become apparent to those of ordinary skill in the art by reading the following detailed description, with reference where appropriate to the accompanying drawings. Further, it is understood that this summary is merely an example and is not intended to limit the scope of the invention as claimed.

### BRIEF DESCRIPTION OF THE DRAWINGS

FIG. 1A is a block diagram of a mobile 3G network;

FIG. 1B is a block diagram of a mobile 2G network coupled to a CSD network;

FIG. 2A is a block diagram of simplified protocol stacks of the network of FIG. 1B;

FIG. 2B is a block diagram of simplified protocol stacks of the network of FIG. 1A;

FIG. 3A is a block diagram of a mobile network with a mobile 3G air interface coupled to a CSD network;

FIG. 3B is a flow diagram of a call setup request at a PDSN;

FIG. 4 is a call flow diagram of the mobile network of FIG. 3A; and

FIG. 5 block diagram of simplified protocol stacks of the network of FIG. 3A.

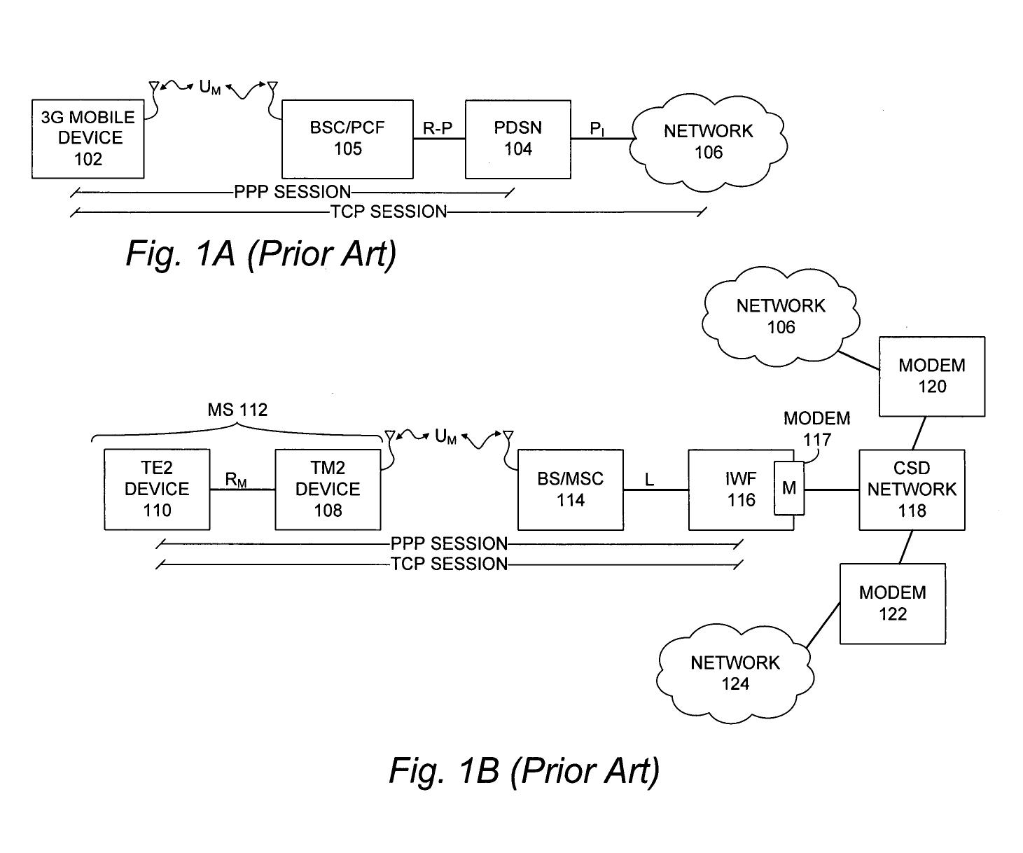

### DETAILED DESCRIPTION

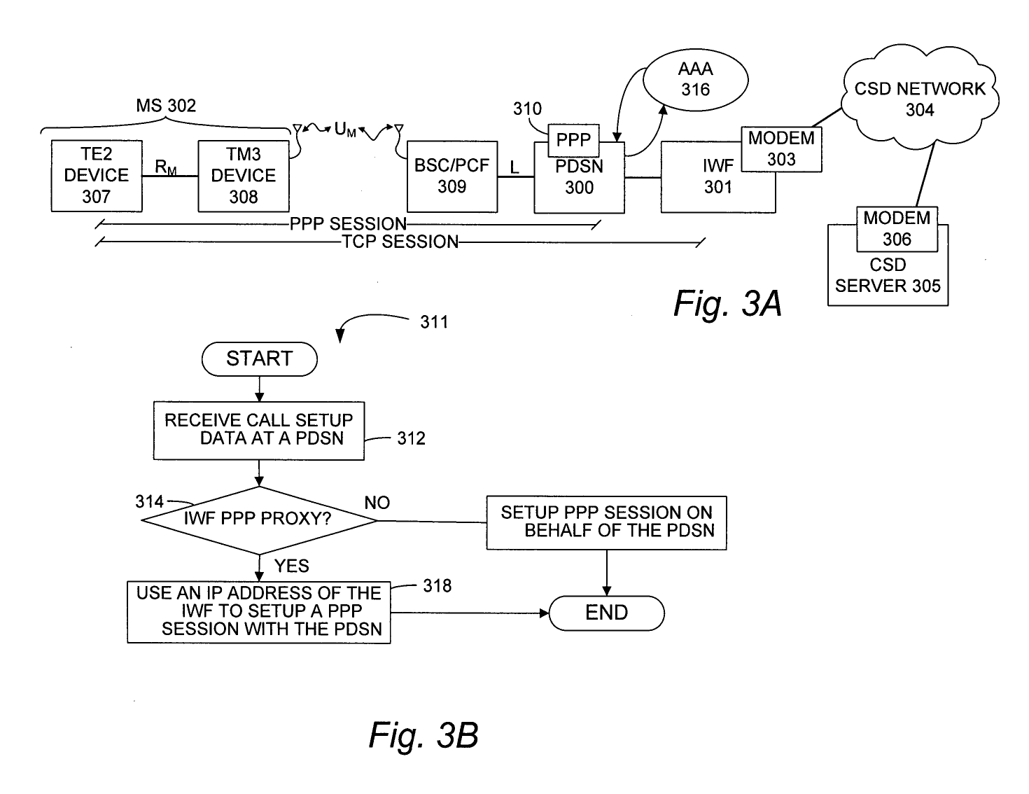

In many circumstances, bypassing a CSD network and allowing the application data to remain packetized allows data transmission to be more efficient. However, as discussed above, there are circumstances where legacy systems (that may be limited to a CSD interface) may not be able to (or desirable to) interface with mobile 3G networks. The existing infrastructures associated with such systems may not be compatible or may require costly upgrades. In these instances and others, an improved PDSN may be included in a 3G mobile network so that legacy systems may still be accommodated. PDSN 300, illustrated in FIG. 3A, provides such an accommodation by negotiating a PPP session on behalf of an IWF 301. Upon establishment of the PPP session, a TCP session may be setup between a MS 302 and the IWF 301. After the TCP session is setup, modem emulation data may be exchanged with IWF 301. Upon receiving the modem emulation data, modem 303 (included in IWF 301) will ultimately allow MS 302 to communicate over CSD Network 304 with CSD server 305 (via a modem 306 within CSD server 305).

In order to exchange data over a 3G air interface, MS 302 includes a 2G mobile device (TE2 device 307) coupled to TM3 device 308. TM3 device 308 may be an adapted version of TM2 device 108. For example, TM2 device 108 may be upgraded so that it may communicate over an air interface according to a mobile 3G standard. The air interface is not limited to only being 3G , however. A variety of air interfaces may be used in order to establish a PPP session with PDSN 300. In addition, TM3 device 308 may include hardware that allows an R_{M} link to be established. This hardware, for example, may establish a second PPP session between TE2 device 307 and TM3 device 308. Or, as in the example above, an RS-232 serial connection may be provided. It should also be noted that MS 302 may be equivalent or similar to 3G mobile device 102.

At a terminating end of the air interface is BSC/PCF 309. BSC/PCF 309 is coupled to PDSN 300 over an R-P interface. PDSN 300 may include all of the functions of PDSN 104. However, PDSN 300 is also adapted so that it may establish a PPP session on behalf of IWF 301. In particular, the PDSN 300 is adapted to recognize an instruction from an AAA server that an IWF PPP proxy session should be established. In addition, the PDSN 300 may include a PPP module 310 that is able to utilize an IP address other than that of the PDSN (i.e., “spoof”). Alternatively, other types of hardware or software modifications may be made to PDSN 300 to establish the PPP session.

In FIG. 3B, a flow diagram shows a method 311 that, in a simplified form, demonstrates a call setup request at a PDSN. At block 312, a PDSN receives call setup data from a MS. Preferably, the call setup data includes either the International Mobile Subscriber Identity (IMSI) data, or the Electronic Serial Number (ESN), or the user's domain name.

In one scenario, the call setup data may be received when the MS is within range of a BSC and the MS is attempting to logon to the wireless network. In an alternative scenario, the MS may already be logged on to the wireless network and a user of the MS may desire to be connected to a CSD server.

In the alternative scenario, the user may have a standard PPP (not IWF PPP proxy) session established and have a pre-configured IWF IP address. A “CSD service” could be started anytime after the PPP session has been setup, which initiates a TCP connection to the IWF and ultimately connect to the CSD server. The PDSN may then determine that the user is attempting to establish a CSD session and then perform tunnel establishment procedures with the IWF. This can be performed by the PDSN by monitoring the destination IP address/TCP port against an IWF IP address list (configured locally or returned from the AAA during initial RADIUS authentication during PPP setup). When the user disconnects the CSD session, only the PDSN-IWF session is disconnected, not the PPP session itself. This would allow normal 3G packet data sessions (for example web-surfing) to coexist with CSD sessions from the same user at the same time.

Returning to the first scenario, the call setup data may directly or indirectly instruct the PDSN to setup a PPP session on behalf of the IWF (i.e., perform an “IWF PPP proxy”) as shown at block 314. For instance, the call setup data may include an IWF forwarding indicator that indicates to the PDSN that an IWF PPP proxy should take place. Preferably, however, after receiving the call setup data, the PDSN may receive the IWF forwarding indicator when authenticating the MS via an Authentication, Authorization, and Accounting (AAA) server. For example, in FIG. 3A, upon receiving the call setup data, PDSN 300 may send an AAA request (preferably according to the RADIUS protocol) to AAA server 316. The AAA server 316 may then look up MS 302 in a database and determine whether IWF 301 is to be used. The AAA response may then include an IWF forwarding indicator. The IWF forwarding indicator may be included in a RADIUS vendor-specific attribute which is included in a RADIUS access accept, for instance. In a similar fashion, the authentication may utilize other protocol messaging formats, such as IMSI registration, and the IWF forwarding indicator may be included in the IMSI messaging. Returning now to FIG. 3B, if the PDSN determines that the IWF PPP proxy should take place, the PDSN then uses an IP address associated with the IWF to set up the PPP session, shown at block 318.

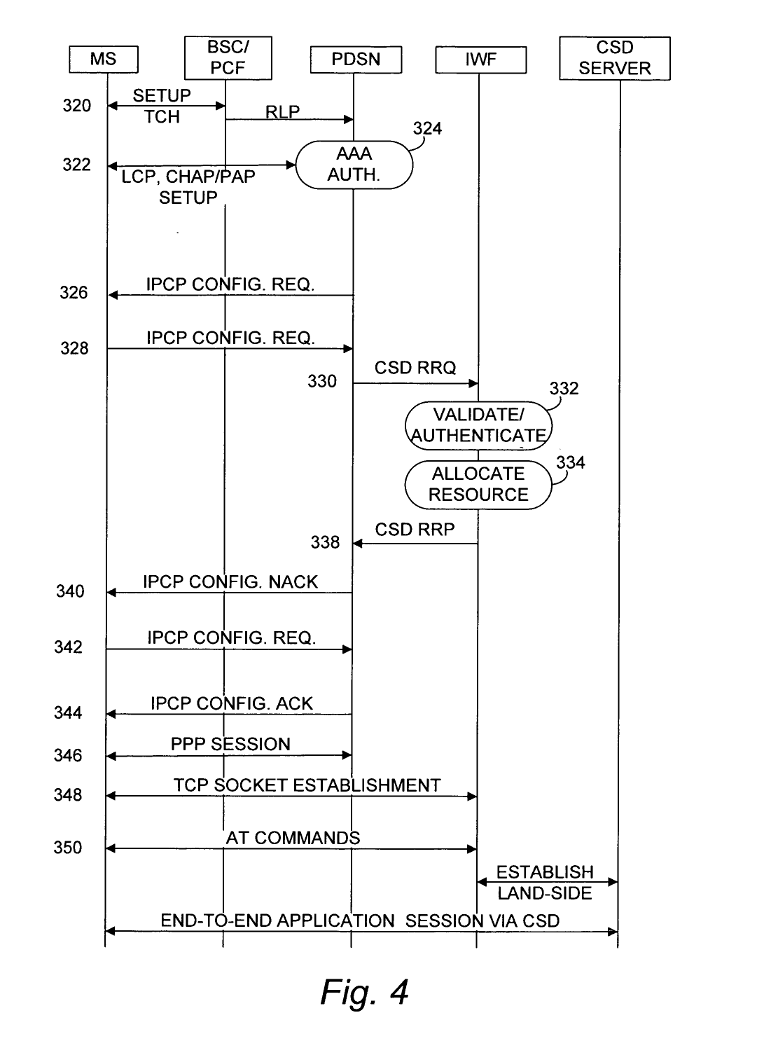

The call flow diagram of FIG. 4 describes in more detail how the PDSN acquires the IP address of the IWF and therefore establishes the IWF PPP proxy, a TCP session, and eventually a CSD session. At 320, a MS and a BSC/PCF set up an RLP channel. After setup of the RLP channel, at 322, LCP negotiations take place. Preferably, the connection request from the MS includes the IMSI, ESN, and/or user's domain. At step 324 the PDSN submits a request for authentication to an Authentication, Authorization, and Accounting (AAA) server. The request preferably conforms to the RADIUS protocol, and includes one or more of the data fields that identify the user. The AAA server uses the call setup data, which is sufficient to indicate whether a 2G-based modem session should be provisioned via an IWF. The AAA server responds with an indication that the PPP module of the PDSN should act as an IWF PPP proxy by “spoofing” the IP address of the IWF. Preferably, the AAA server provides the PDSN with the IP address of the IWF (e.g., a RADIUS vendor-specific attribute in the RADIUS access accept message). The AAA server may select the IWF IP address statically, from an address pool, and/or based on a load balancing algorithm.

Also, as discussed previously, it is contemplated that the PDSN may have received the IWF forwarding indicator from a mobile station that has already logged onto a network and has already completed LCP negotiations with the PDSN. In this scenario, the PDSN may initiate an IWF PPP proxy at a MS user's request.

In any event, at 324 the PDSN detects that an IWF PPP proxy should occur. The MS and the PDSN then undergo IPCP negotiations. At 326, the PDSN identifies itself (“spoofs”) as having a source IP address of the IWF. Simultaneously at 328, the MS sends an IPCP configuration request including a source IP address of all zeros, indicating a request for the assignment of an IP address. At 330 the PDSN forwards a CSD request to the IWF. The PDSN may forward the CSD request to the IWF using IP routing procedures, preferably using Unreliable Datagram Protocol (UDP).

At 332, the IWF validates and authenticates the CSD request. If validation and authentication is successful, the IWF allocates a landside resource at 334. At 338, a CSD reply is sent to the PDSN. At this point, it should be noted that the CSD request and reply messages may take on a variety of forms. They may, for instance, be an extension of mobile IP. Alternatively, The CSD messages could use UDP destined to a specific port (for example 34,000). A CSD message may generally contain the following fields:
Message type (request/response)
Mobile's IP address
IWF IP address
PDSN IP address
Timestamp to verify that the message cannot be replayed.
Calling station ID (user identity)
Electronic Serial Number (equipment identity)
Service Option
Authenticator to verify if the message is valid.

When the PDSN receives the CSD reply message, it sends an IPCP NACK message to the MS at 340. The NACK message rejects the original IPCP configuration request and it includes the IP address determined by the IWF. Again, the IPCP negotiation messages sent from the PDSN use the IWF IP address as the source IP address. Next, at 342 the MS sends a second IPCP configuration request to the PDSN. The second IPCP configuration request, this time, however, includes the MS source IP address designated by the PDSN. Upon receipt of this request, the PDSN sends an IPCP ACK response to the MS and at 346 a PPP session is established between the MS and the PDSN.

When the PPP setup is complete, at 348 a TCP/IP session may be set up between the MS and the IWF. Then, at 350, modem emulation data may then be communicated to a modem within the IWF and therefore allow the MS to communicate over a CSD network with a CSD server. Thus the MS communicates through a 3G air interface using the PDSN and, it also communicates through the CSD network using the IWF.

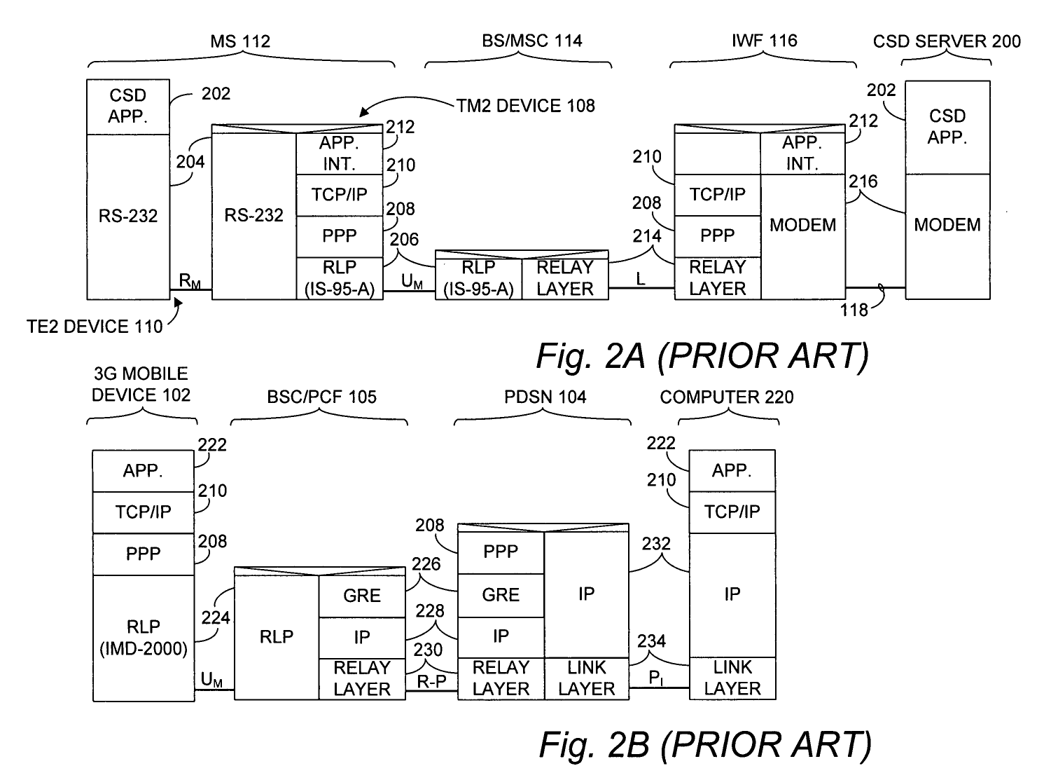

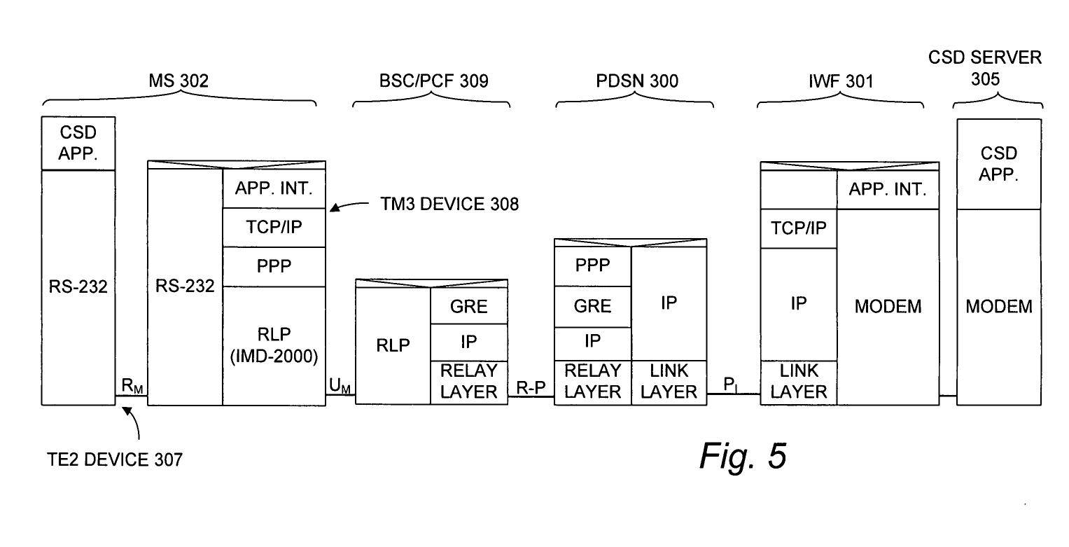

Although a PDSN may be adapted to establish a data session using an IWF PPP proxy, the protocol stacks used to provide the data exchange between a MS (such as MS 302) and a CSD server (such as CSD server 305), may be similar to those described with reference to FIGS. 2A-2B. FIG. 5 is a block diagram of simplified protocol stacks used in the mobile network of FIG. 3A. A distinction between FIG. 5 and FIGS. 2A is the RLP interface is in accordance with the IMD-2000 specification. A distinction between FIG. 5 and FIG. 2B is that the P_{I} interface is used to exchange communications between a PDSN and an IWF.

As described above, a PDSN may undergo a software or hardware modification so that it may serve as an IWF PPP proxy. In addition, an IWF may also undergo modifications. Because the IWF is no longer responsible for setting up a PPP session, these modifications may allow the IWF to receive TCP/IP packets and then relay them over a CSD network via a modem. Alternatively, the IWF may include a tunneling agent that the IWF uses to receive packets that are sent from the PDSN.

Overall, it should be understood that other adaptations may be made to the protocol stacks, the MS, the PDSN, the IWF, and call flows without deviating from the scope and spirit of the present invention. For example, additional modules may be added to a PDSN. A routing or tunneling module, for example, may be added to facilitate data exchange between the PDSN and an IWF. The described methods of operating the PDSN, and in particular, the method of establishing a PPP session on behalf of the IWF should not be taken as limiting the scope of the invention. The claims should not be read as limited to the described order or unless stated to that effect. Therefore, all embodiments that come within the scope and spirit of the following claims and equivalents thereto are claimed as the invention.

We Claim:

1. A method of operating a Packet Data Serving Node (PDSN) to provide communications to an Inter Working Function (IWF), the method comprising:
providing a PDSN having a Point-to-Point Protocol (PPP) module coupled to an R-P interface and also coupled to a P_{I} interface, wherein the P_{I} interface provides a communication link to an IWF;
establishing a PPP session between a mobile device and the PPP module via the R-P interface, wherein the PPP module use an IP address associated with the IWF, and wherein the PPP session carries IWF data traffic; and
forwarding the IWF data traffic from the PPP session to the IWF via the P_{I} interface.

2. The method of claim 1 wherein establishing the PPP session comprises performing Internet Protocol Configuration Protocol (IPCP) negotiations.

3. The method of claim 1, further comprising the PPP module receiving Authentication, Authorization, and Accounting (AAA) data that includes an IWF forwarding indicator.

4. The method of claim 1, wherein forwarding the IWF data traffic to the IWF is performed using IP routing procedures to route the IWF data traffic to the IWF.

5. The method of claim 1, wherein the PPP module terminates the PPP session with the mobile, and wherein the IWF terminates a Transmission Control Protocol (TCP) session with the mobile.

6. The method of claim 1, wherein forwarding IWF data traffic to the IWF comprises tunneling the IWF data traffic via a tunneling protocol.

7. The method of claim 1, wherein forwarding IWF data traffic to the IWF comprises tunneling the IWF data traffic via a Layer 2 Tunneling Protocol (L2TP).

8. A method of operating a Packet Data Serving Node (PDSN) to provide communications to an Inter Working Function (IWF), the method comprising:
establishing a Point-to-Point Protocol (PPP) session with a Mobile Station (MS) at a PDSN on behalf of an Inter Working Function (IWF) by utilizing the IP address of the IWF;
receiving network layer packets from the MS via the PPP session, the network layer packets having a destination address of the IWF; and
forwarding the network layer packets to the IWF.

9. The method of claim 8, wherein the network layer packets contain modem emulation data.

10. The method of claim 9, wherein the modem emulation data are carried via a Transmission Control Protocol (TCP) session.

11. The method of claim 10, wherein the TCP session endpoints are the IWF and the MS.

12. The method of claim 8, further comprising prior to establishing the PPP session, obtaining Authentication, Authorization, and Accounting (AAA) data comprising an IWF forwarding indicator.

13. The method of claim 8, wherein the step of forwarding the network layer packets comprises providing the network layer packets to a PDSN routing module.

14. The method of claim 8, wherein the step of establishing a PPP session with a MS comprises broadcasting the IP address of the IWF from the PDSN during Internet Protocol Configuration Protocol (IPCP) negotiations.

15. A Packet Data Serving Node (PDSN) for providing communications to an Inter Working Function (IWF), comprising a Point-to-Point Protocol (PPP) module for establishing a PPP session with a mobile device, wherein the PPP module is adapted to establish the PPP session using an IP address associated with the IWF.

16. The PDSN as in claim 15, further comprising an IWF forwarding module for forwarding network layer packets to the IWF.

17. The PDSN as in claim 16, wherein the IWF forwarding module forwards the network layer packets to the IWF by tunneling the network packets to the IWF according to a tunneling protocol.
